(19) United States
(12) Patent Application Publication
(10) Pub. No.: US 2023/0367978 A1
(43) Pub. Date: Nov. 16, 2023

(54) CROSS-LINGUAL APPARATUS AND METHOD

(71) Applicant: HUAWEI TECHNOLOGIES CO., LTD., Shenzhen (CN)

(72) Inventor: Milan GRITTA, London (GB)

(21) Appl. No.: 18/360,964

(22) Filed: Jul. 28, 2023

Related U.S. Application Data
(63) Continuation of application No. PCT/EP2021/052047, filed on Jan. 29, 2021.

(51) Int. Cl. G06F 40/58; G06F 40/30; G10L 15/18; G06N 3/08

(52) U.S. Cl. CPC G06F 40/58; G06F 40/30; G10L 15/1822; G06N 3/08

(57) ABSTRACT

Described is an apparatus and method for cross-lingual training between a source language and at least one target language. The method comprises receiving a plurality of input data elements, training a neural network model by repeatedly: i. selecting one of the plurality of input data elements; ii. obtaining a first representation of the first linguistic expression of the selected input data element by means of the neural network model; iii. obtaining a second representation of the second linguistic expression of the selected input data element by means of the neural network model; iv. forming a first loss in dependence on the performance of the neural network model on the first linguistic expression; v. forming a second loss indicative of a similarity between the first representation and the second representation; and vi. adapting the neural network model in dependence on the first and second losses.

### CROSS-REFERENCE TO RELATED APPLICATIONS

This application is a continuation of International Application No. PCT/EP2021/052047, filed on Jan. 29, 2021, the disclosure of which is hereby incorporated by reference in its entirety.

### FIELD OF THE INVENTION

This invention relates to the transfer of task knowledge from one language to another language using a cross-lingual pretrained language model.

### BACKGROUND

Cross-lingual transformers are a type of pretrained language model which are the dominant approach in much of Natural Language Processing (NLP). These large models are able to compute with multiple languages because of their multilingual vocabulary that covers over 100 languages, having been pretrained on large datasets, sometimes with parallel data.

In Supervised Learning, labelled data is required for model training in each language and each task. However, for most languages, this is not available. Frequently, this problem is addressed by translating into the language it is desired to cover and training on one or both languages, or aligning the model using translated data as either a pretraining task (large-scale training) or multi-task (where only task-specific data is used).

One prior art method is Translate+Train. In this method, the model is trained in a conventional supervised manner, where the training data is usually translated from English into the under-resourced target language. The Test+Translate variant is similar, but the test data is translated from target to source language (usually back to English) and uses a model trained in the well-resourced language. In addition, tasks such as Named Entity Recognition also require label alignment, as the order of words changes once translated into a different language. Fastalign (as described in Dyer et al., “A simple, fast, and effective reparameterization of ibm model 2”, Proceedings of the 2013 Conference of the North American Chapter of the Association for Computational Linguistics: Human Language Technologies, pp. 644-648. 2013) is a popular method to match each word in a sentence (in one language) to its counterpart(s) in the translated sentence, although the improvement to zero-shot performance is limited.

Another known approach is Contrastive Learning (CL) (as described in Becker et al., “Self organizing neural network that discovers surfaces in random-dot stereograms”, Nature, Vol. 335, No. 6356, p. 161-163 (1992)). CL in NLP is designed to improve the sentence representations for different languages by maximizing the similarity of positive samples (with the same sentence meaning) and minimizing the similarity of negative (with dissimilar, different sentence meaning) sentences.

The SimCLR, as described in Chen et al., “A simple framework for contrastive learning of visual representations,” arXiv preprint arXiv:2002.05709 (2020), and MoCo, as described in He et al., “Momentum contrast for unsupervised visual representation learning”, Proceedings of the IEEE/CVF Conference on Computer Vision and Pattern Recognition, pp. 9729-9738, 2020, are examples of CL methods, which use two transformers to compute the loss. Positive and Negative samples are required as well. The CLS token, as described in Pan et al., “Multilingual BERT Post-Pretraining Alignment.” arXiv preprint arXiv:2010.12547 (2020) and Chi et al., “Infoxlm: An information-theoretic framework for cross-lingual language model pretraining.” arXiv preprint arXiv:2007.07834 (2020) (‘<s>’ token for XLM-R) is used as a sentence representation. Mean Pooling, as described in Hu et al., “Explicit Alignment Objectives for Multilingual Bidirectional Encoders.” arXiv preprint arXiv:2010.07972 (2020), can be also used as sentence representation. The method depends heavily on the quality of negative samples, which is non-trivial to produce. CL is typically used with large quantities of data and it is not task-specific.

In other approaches, as described in Cao et al., “Multilingual alignment of contextual word representations.” arXiv preprint arXiv:2002.03518 (2020), a combination of data and model alignment uses individual word representations to align model with an attention matrix (sentence align results are worse than translate-train but improvement for word align) or a reconstruction attention matrix, as described in Xu et al., “End-to-End Slot Alignment and Recognition for Cross-Lingual NLU.” arXiv preprint arXiv:2004.14353 (2020). LaBSe, as described in Feng et al., “Language-agnostic bert sentence embedding.” arXiv preprint arXiv:2007.01852 (2020), uses the CLS token but is optimized for general task multilingual sentence embeddings trained with large data quantities.

It is desirable to develop a method for training models for cross-lingual applications that overcomes the problems of the prior art.

### SUMMARY OF THE INVENTION

According to one aspect there is provided an apparatus for cross-lingual training between a source language and at least one target language, the apparatus comprising one or more processors configured to perform the steps of: receiving a plurality of input data elements, each of the plurality of input data elements comprising a first linguistic expression in the source language and a second linguistic expression in the target language, the first and the second linguistic expressions having corresponding meaning in their respective languages; and training a neural network model by repeatedly: i. selecting one of the plurality of input data elements; ii. obtaining a first representation of the first linguistic expression of the selected input data element by means of the neural network model; iii. obtaining a second representation of the second linguistic expression of the selected input data element by means of the neural network model; iv. forming a first loss in dependence on the performance of the neural network model on the first linguistic expression; v. forming a second loss indicative of a similarity between the first representation and the second representation; and vi. adapting the neural network model in dependence on the first and second losses.

Training the neural network model in this way may further improve the performance of state-of-the-art models in cross-lingual natural language understanding and classification tasks.

The performance of the neural network model may be determined based on the difference between an expected output and an actual output of the neural network model. This may allow the performance of the model to be conveniently determined.

The neural network model may form representations of linguistic expressions according to their meaning. This may allow the input data elements to be classified.

At least some of the linguistic expressions may be sentences. This may conveniently allow representations to be formed for conversational or instructional phrases that can be used to train the model.

Prior to the training step the neural network model may be more capable of classifying linguistic expressions in the first language than in the second language. For example, the first language may be English, for which labelled data is readily available. After the training step the neural network model may be more capable than before the training step of classifying linguistic expressions in the second language. Thus the training step may improve the performance of the model in classifying linguistic expressions in the second language.

The neural network model may comprise a plurality of nodes linked by weights and the step of adapting the neural network model comprises backpropagating the first and second losses to nodes of the neural network model so as to adjust the weights. This may be a convenient approach for updating the neural network model.

The second loss may be formed in dependence on a similarity function representing the similarity between the representations by the neural network model of the first and second linguistic expressions of the selected input data element. The similarity function may be any function that takes as input two embeddings/vectors and computes the distance between them, (for example, MSE, MAE, Dot Product, Cosine, etc.). This may help to ensure that the embeddings are similar in both languages (aligned), which can result in improved zero-shot performance.

The neural network model may be capable of forming an output in dependence on a linguistic expression and the training step comprises forming a third loss in dependence on a further output of the neural network model in response to at least the first linguistic expression of the selected data element and adapting the neural network model in response to that third loss. Further losses may be added for the main/primary task.

The output may represent a sequence tag for the first linguistic expression. The main task may therefore comprise a sequence tagging task, such as slot tagging, where each token in the sequence is classified with a type of entity.

The output may represent predicting a single class label or a sequence of class labels for the first linguistic expression. Any additional loss(es) may come from other tasks such as a Question & Answer task or a Text Classification task, for example.

The training step may be performed in the absence of data directly indicating the classification of linguistic expressions in the second language. Using zero-shot learning may allow transfer of the task knowledge, represented as annotations or labels in one language, to languages without any training data. This may reduce the computational complexity of the training.

The apparatus may further comprise the neural network model. The model may be stored at the apparatus.

According to a second aspect there is provided a data carrier storing in non-transient form data defining a neural network classifier model being capable of classifying linguistic expressions of a plurality of languages, and the neural network classifier model being configured to output the same classification in response to linguistic expressions of the first and second languages that have the same meaning as each other.

The neural network classifier model may be trained by the apparatus described above. This may allow the trained neural network model to be implemented in an electronic device, such as a smartphone, for practical applications.

According to a further aspect there is provided a linguistic analysis device comprising a data carrier as described above, an audio input and one or more processors configured to: receive input audio data from the audio input; apply the input audio data as input to the neural network classifier model stored on the data carrier to form an output; and perform a control action in dependence on the output. This may, for example, allow electronic devices to be controlled using voice input.

The linguistic analysis device may be configured to implement a voice assistant function by means of the neural network classifier model stored on the data carrier. This may be desirable on modern electronic devices such as smartphones and speakers. Other applications are possible.

The audio input may be a microphone comprised in the device. The audio input may be a wireless receiver for receiving data from a headset local to the device. These implementations may allow the device to be used in a voice assistant application.

According to another aspect there is provided a method for cross-lingual training between a source language and at least one target language, the method comprising performing the steps of: receiving a plurality of input data elements, each of the plurality of input data elements comprising a first linguistic expression in the source language and a second linguistic expression in the target language, the first and the second linguistic expressions having corresponding meaning in their respective languages; and training a neural network model by repeatedly: i. selecting one of the plurality of input data elements; ii. obtaining a first representation of the first linguistic expression of the selected input data element by means of the neural network model; iii. obtaining a second representation of the second linguistic expression of the selected input data element by means of the neural network model; iv. forming a first loss in dependence on the performance of the neural network model on the first linguistic expression; v. forming a second loss indicative of a similarity between the first representation and the second representation; and vi. adapting the neural network model in dependence on the first and second losses.

This method of training the neural network model may further improve the performance of state-of-the-art models in cross-lingual natural language understanding and classification tasks.

The method can also be applied to raw text that has been obtained by methods other than audio signals, for example crawling the internet for data.

### BRIEF DESCRIPTION OF THE FIGURES

The present invention will now be described by way of example with reference to the accompanying drawings. In the drawings:

FIG. 1 shows a schematic illustration of the cross-lingual NLU multi-task architecture.

FIG. 2 shows a schematic illustration of the method using an alignment task integrated into the XNLU architecture shown in FIG. 1.

FIG. 3 shows a brief description of an example of the alignment algorithm for the approach described herein.

FIG. 4 summarises an example of a method for cross-lingual training between a source language and at least one target language.

FIG. 5 shows an example of apparatus comprising a linguistic analysis device.

FIGS. 6(a) and 6(b) show a comparison between the present method in FIG. 6(a) (XLM-RA embodiment) using alignment loss versus the prior method of contrastive alignment loss in FIG. 6(b).

FIG. 7 depicts differences between some known methods versus embodiments of the method described herein.

FIG. 8 refers to methodological differences between some embodiments of the approach described herein and some known methods.

FIG. 9 outlines differences between the loss function used in some embodiments of the method described herein and contrastive loss.

### DETAILED DESCRIPTION

Embodiments of the present invention concern the transfer of task knowledge from one language to another language using a cross-lingual pretrained language model (PXLM).

Embodiments of the present invention preferably use zero-shot learning, with the aim of transferring the task knowledge, represented as annotations or labels in one language, to languages without any training data. Zero-shot learning refers to the PXLM's ability to generalise the task knowledge from one language to another language with no labelled data available in that language(s).

The model can be trained on a language (or multiple languages) such as English (with available labels) and tested on a language (or languages) for which no labelled data is available. This is because, generally, PXLMs do not adequately generalise i.e. they do not achieve the same task performance on languages without explicitly annotated data.

The approach described herein aims to improve zero-shot task performance of PXLMs on unlabelled languages (which is most languages). Thus, the training step can be performed in the absence of data directly indicating the classification of linguistic expressions in the second language, which may be unlabelled.

In the approach described herein, during training, a plurality of input data elements are received which are used as training data to train a neural network. Each of the plurality of input data elements comprises a first linguistic expression in the source language (for example, English) and a second linguistic expression in the target language (for example, Thai). The first and the second linguistic expressions have corresponding (i.e. like) meaning in their respective languages.

The training data is used to train the neural network model. The neural network model may form representations of linguistic expressions according to their meaning. Preferably, at least some of the linguistic expressions are sentences.

One of the plurality of input data elements is selected and a first representation of the first linguistic expression of the selected input data element is obtained by means of the neural network model. A second representation of the second linguistic expression of the selected input data element is also obtained by means of the neural network model. A first loss is formed in dependence on the performance of the neural network model on the first linguistic expression. The performance of the neural network model may be determined based on the difference between an expected output and an actual output of the neural network model. A second loss is formed that is indicative of a similarity between the first representation and the second representation. The neural network model is then adapted in dependence on the first and second losses until convergence. The neural network model may comprise a plurality of nodes linked by weights and the step of adapting the neural network model comprises backpropagating the first and second losses to nodes of the neural network model so as to adjust the weights.

Prior to the training step the neural network model may be more capable of classifying linguistic expressions in the first language than in the second language. The training of the model may improve the ability of the model to classify the input linguistic expressions in the second language.

The neural network model may be capable of forming an output in dependence on a linguistic expression. The training step may comprise forming a third loss in dependence on a further output of the neural network model in response to at least the first linguistic expression of the selected data element and adapting the neural network model in response to that third loss. Further losses may be added for the primary task.

In some implementations, the output may represent a sequence tag for the first linguistic expression. In other cases, the output may represent predicting a single class label or a sequence of class labels for the first linguistic expression.

In a preferred implementation, the model is a transformer model. The transformer model is based on a pretrained language model. In the examples described herein, the PXLM model is XLM-Roberta (XLM-R), as described in Conneau et al., “Unsupervised cross-lingual representation learning at scale”, arXiv preprint arXiv:1911.02116 (2019). XLM-R is a publicly available pretrained model from the Huggingface (https://huggingface.co/) team. Others models may be used.

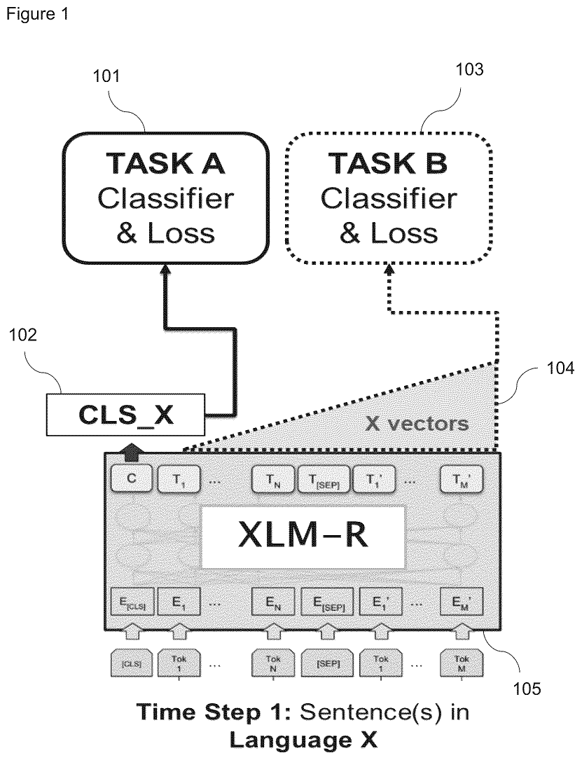

FIG. 1 schematically illustrates an example of a main task. In some embodiments, multi-tasking (for example, MTOP, as described in Li et al., “MTOP: A Comprehensive Multilingual Task-Oriented Semantic Parsing Benchmark”, arXiv preprint arXiv:2008.09335 (2020) and Schuster et al., “Cross-lingual transfer learning for multilingual task oriented dialog”, arXiv preprint arXiv:1810.13327 (2018)) may be used.

For example, cross-lingual natural language understanding (XNLU) is an instance of combining two related tasks, TASK A and TASK B, in the example of FIG. 1. XNLU requires the optimization of two sub-tasks, Intent Classification and Slot Tagging.

Other NLP tasks may also be used. For example, Sentiment Analysis assigns ‘positive’, ‘negative’ or ‘neutral’ labels to a text input. Multiple choice Q&A can also be formulated as a classification task. There may be more than one primary task loss. For example, in a personal assistant application, two tasks are learned simultaneously, but this may not be the case for other applications.

There is labelled data for some NPL task, Task A 101 (and one or more further tasks B, C etc. if multi-tasking), in the source language (Language S). In this example, the aim is to maximize zero-shot performance on Task A (and the one or more further tasks if multi-tasking) in the target language (Language T) but without any labelled data for Language T, only using translated/parallel training data (from Language S to T).

In the example of FIG. 1, TASK A, shown at 101, is a Text Classification task. In this task, given a sentence/paragraph or some other sequence of tokens, the aim is to determine the class/type/relation of the input text. This may be done using any convenient method, including those known in the art, such as Intent Classification in Conversational Al (see Li et al., “MTOP: A Comprehensive Multilingual Task-Oriented Semantic Parsing Benchmark.” arXiv preprint arXiv:2008.09335 (2020) and Schuster et al., “Cross-lingual transfer learning for multilingual task oriented dialog.” arXiv preprint arXiv:1810.13327 (2018)).

CLS is a sentence/input embedding/representation (the meaning of the sentence or input). CLS_X, shown at 102, is a sentence/input embedding/representation of language X.

In the example of FIG. 1, TASK B, shown at 103, is a Sequence Tagging task. Slot Tagging is an example of Sequence Tagging where each token in the sequence needs to be classified with a type of entity (tokens also have no entity type).

X vectors, illustrated at 104, are token embeddings for text input in language X for example for NER, XNLU (Li et al., 2020).

The transformer model XLM-R is shown at 105. In other implementations, the transformer need not be an XLM-R, but could be a different type of model.

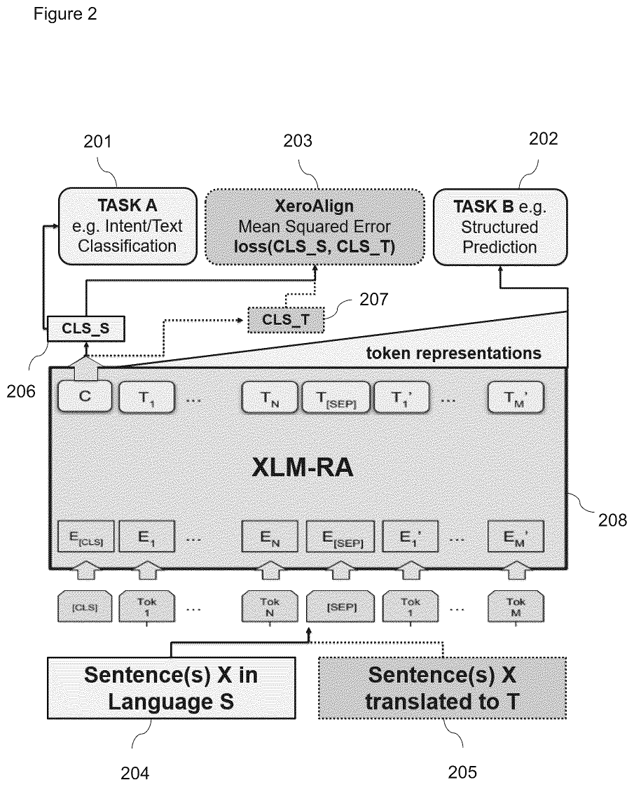

FIG. 2 shows an exemplary diagram of the method described herein integrated into XNLU task training with the XLM-R transformer (described in Conneau et al., “Unsupervised cross-lingual representation learning at scale”, arXiv preprint arXiv:1911.02116 (2019)).

In this example, multi-tasking is used, with the main task comprising Tasks A and B, shown at 201 and 202 respectively. However, in other examples, the main task may comprise only one task (i.e. Task A).

An additional alignment task is added, as shown at 203. An alignment loss function is added to the main task training. The loss is computed (with task data and translated task data) as the difference between the sentence(s) representation/embeddings (which may be referred to as a CLS token) of two sentences with the same meaning (but encoded separately). These embeddings are therefore input/sentence representations obtained from the contextualized token representations generated by a single model (208 in FIG. 2).

S and T denote Language S and Language T respectively (also referred to as Source S and Target T). The input data elements in Language S may comprise labelled data. The input data elements in Language T may be created based on the input data elements in Language S. In this example, the inputs are one or more sentences X in Language S, shown at 204, and X translated from S into T, shown at 205.

CLS_S, 206, and CLS_T, 207, are the embeddings or representations obtained from the input data elements in languages S and T, respectively. CLS_S and CLS_T are obtained from the same model 208, but at different time steps (with separate encoding).

The alignment task 203 is trained jointly with Task A 201 and/or Task B 202. CLS_T 207 is not used for the main task, only for alignment.

In this example, Tasks A and B are trained in the conventional way with no modifications using only CLS_S as input. An additional task loss is added using, for example, Mean Squared Error (MSE) as the similarity function that computes the distance between CLS_S and CLS_T. This trains the model to produce similar embeddings for different languages translated from the same sentence. The overall aligned model described herein may be referred to as XLM-RA (A is for aligned). The classifier for Task A can be re-used as CLS_T after training has become more similar to CLS_S. This may enable the transfer of the task ‘knowledge’ in a zero-shot manner.

Preferably, the loss function of the alignment task makes use of a similarity function. The similarity function may represent the similarity between the representations by the neural network model of the first and second linguistic expressions of the selected input data element. The similarity function used inside the loss function is preferably the MSE, but can be a different function. It may be any function that takes as input two embeddings/vectors and computes the distance between them, (e.g. MAE, Dot Product, Cosine, etc.). This ensures the embeddings are similar in both languages (aligned), which can result in improved zero-shot performance.

Negative samples (sentences that have a different meaning from the linguistic expressions in the first language that are used to compute dissimilarity) are not required for the loss function.

The transformer model is trained to maximize performance on Task A (and Task B, C etc. if multi-tasking) in Language S. The model is also trained to align the transformer to generate similar sentence embeddings for Language S and T (for parallel sentences/inputs).

The main task is therefore optimized based on the input data elements in language S and the loss function of the alignment task.

The multi-task training with alignment may teach the transformer model to be consistent with itself when generating multilingual representations. Two sentences with the same meaning in Languages S and T should have the same, or similar, embeddings. The method ensures the embeddings are similar (aligned) in both languages, resulting in improved zero-shot performance.

Advantageously, when sentence embeddings for S and T are highly similar after training, more Task A (B, C, etc.) performance can be transferred from Language S to Language T without any training data in Language T.

Therefore, the PXLM model is trained to maximize performance on the Task in Language S while aligning the transformer to generate similar sentence embeddings for Language S and T using parallel sentences (translated from S to T). When the sentence embeddings for S and T are highly similar after training, more Task performance can be transferred from Language S to Language T without any training data in Language T. More intuitively, the multi-task training with alignment is forcing the transformer to generate more similar multilingual representations than the unaligned model. That is, if the sentence meaning is the same in Language S and T then the embeddings should also be the same. This may improve zero-shot performance of a pretrained language model with translated training data.

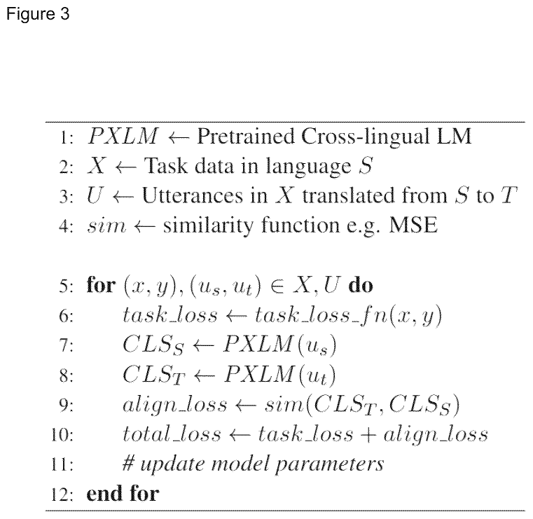

An example of the alignment algorithm is summarized in FIG. 3, showing exemplary steps inside the training loop, before adding the alignment loss to the main task loss and backpropagating all losses.

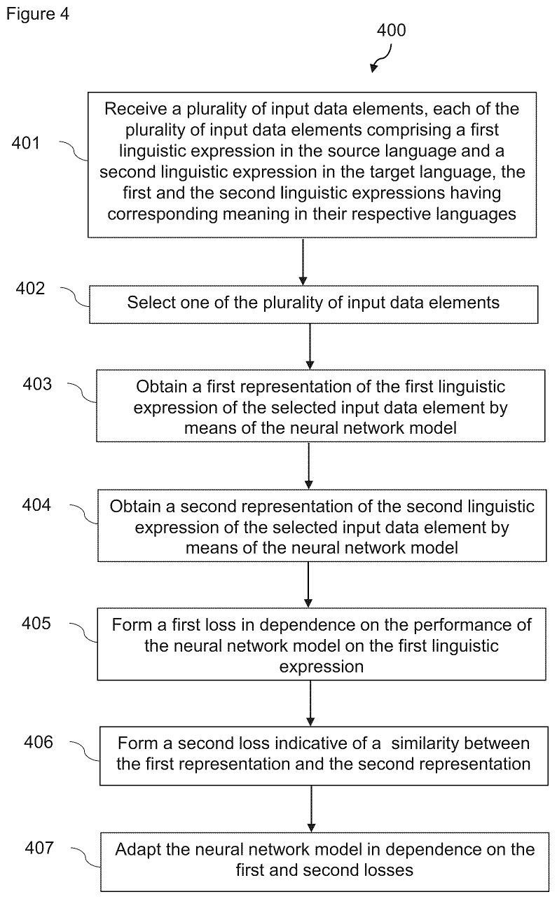

Generally, FIG. 4 shows an example of a computer-implemented method 400 for cross-lingual training between a source language and at least one target language. The method comprises performing the steps shown at 401-407.

At step 401, the method comprises receiving a plurality of input data elements, each of the plurality of input data elements comprising a first linguistic expression in the source language and a second linguistic expression in the target language, the first and the second linguistic expressions having corresponding meaning in their respective languages. In steps 402-407, the method comprises training a neural network by repeatedly performing these steps. At step 402, the method comprises selecting one of the plurality of input data elements. At step 403, the method comprises obtaining a first representation of the first linguistic expression of the selected input data element by means of the neural network model. At step 404, the method comprises obtaining a second representation of the second linguistic expression of the selected input data element by means of the neural network model. At step 405, the method comprises forming a first loss in dependence on the performance of the neural network model on the first linguistic expression. At step 406, the method comprises forming a second loss indicative of a similarity between the first representation and the second representation. At step 407, the method comprises adapting the neural network model in dependence on the first and second losses.

Steps 402-407 may be performed until the model converges. This method may be used to train a neural network classifier model for use in a linguistic analysis device that may, for example, function as a voice assistant in an electronic device such as a smartphone.

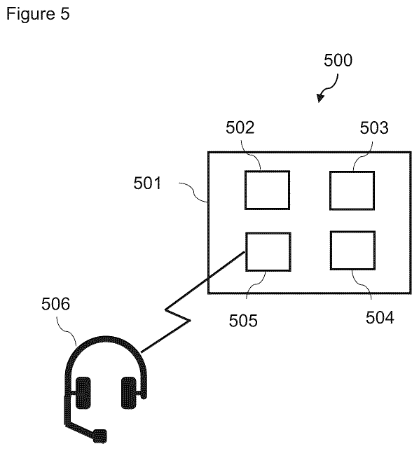

FIG. 5 is a schematic representation of an example of an apparatus 500 comprising linguistic analysis device 501. In some embodiments, the device 501 may also be configured to perform the training method described herein. Alternatively, the training of the model may be performed by apparatus external to the linguistic analysis device and the trained model may then be stored at the device once training is complete. The device 501 may be implemented on an electronic device such as a laptop, tablet, smartphone or TV.

The apparatus 500 comprises a processor 502. For example, the processor 502 may be implemented as a computer program running on a programmable device such as a Central Processing Unit (CPU). The apparatus 500 also comprises a memory 503 which is arranged to communicate with the processor 502. Memory 503 may be a non-volatile memory. The processor 502 may also comprise a cache (not shown in FIG. 5), which may be used to temporarily store data from memory 503. The system may comprise more than one processor and more than one memory. The memory may store data that is executable by the processor. The processor may be configured to operate in accordance with a computer program stored in non-transitory form on a machine readable storage medium. The computer program may store instructions for causing the processor to perform its methods in the manner described herein.

The memory 503 stores in non-transient form data defining the neural network classifier model being capable of classifying linguistic expressions of a plurality of languages and being configured to output the same classification in response to linguistic expressions of the first and second languages that have the same meaning as each other. The device 501 also comprises at least one audio input. The audio input may be a microphone comprised in the device, shown at 504. Alternatively or additionally, the device may comprise a wireless receiver 505 for receiving data from a headset 506 local to the device 501.

The processor 502 is configured to receive input audio data from the audio input, apply the input audio data as input to the neural network classifier model stored on the data carrier to form an output, and perform a control action in dependence on the output.

The linguistic analysis device 501 may be configured to implement a voice assistant function by means of the neural network classifier model stored on the data carrier 503. Other applications are possible.

Instead of obtaining input text from audio signals, the processor 502 may alternatively input data to the neural network classifier model in the form of raw text that has been obtained by, for example, crawling the internet for data.

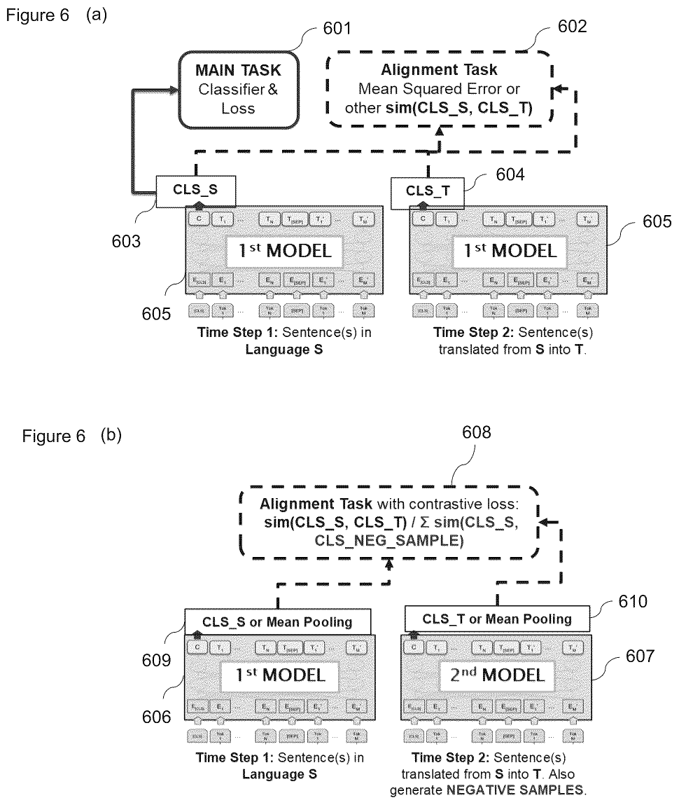

FIGS. 6(a) and 6(b) show a comparison between the present method (referred to as XLM-RA alignment loss) in FIG. 6(a) and the known method of contrastive alignment loss in FIG. 6(b).

As shown in FIG. 6(a), in embodiments of the present invention, the training of the main task 601 that uses labelled data in the well-resourced language does not change. The alignment task 602 loss function is added to the main task training, optimizing the model in a multi-task manner. The alignment loss is computed as the difference between the sentence embedding in the source language CLS_S, 603, and the embedding of the translated sentence in the target language CLS_T, 604. These embeddings are obtained from a single model, 605, such as XLM-R, taking the first token (typically called CLS) as the embedding of the whole input.

For contrastive loss in FIG. 6(b), two models 606 and 607 are required for the loss in the alignment task 608, which train before the main task. Negative samples are required, and CLS or Mean Pooling as used, as shown at 609 and 610.

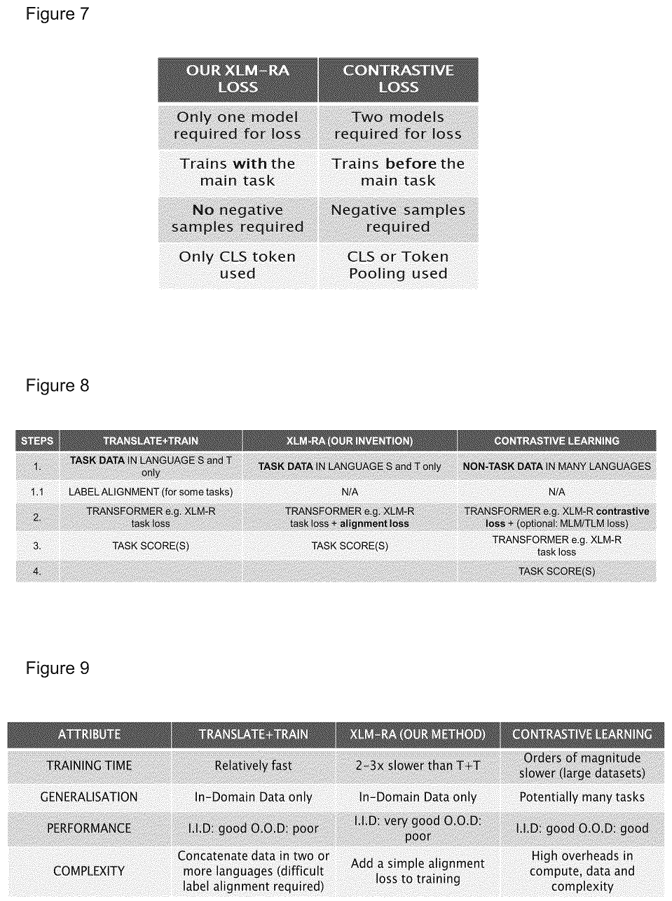

The table shown in FIG. 7 depicts differences between the loss function described herein and the contrastive loss. As discussed with reference to FIG. 6(b), in contrastive loss, two models are required for the loss, which train before the main task. Negative samples are required, and CLS Token or Mean Pooling is used. In contrast, in the method described herein, only one model is required for the loss which trains with the main task. No negative samples are required and only CLS token is used. Instead of CLS token, Mean Pooling could alternatively be used.

The table shown in FIG. 8 depicts features of the prior art methods Translate+Train and Contrastive Learning versus the method described herein according to some embodiments (implemented as XLM-RA). As described above, in this implementation, the method described herein uses task data in languages S and T only, transformer task loss and alignment loss, and task scores.

The table shown in FIG. 9 refers to methodological differences between the approach described herein and the prior art (Translate+Train and Contrastive Learning). Although in some implementations, the present method is slower than Translate+Train in terms of computation time, the simple alignment loss added to the training greatly reduces the complexity of the method.

In terms of complexity, the method does not use any negative samples, which makes it more efficient and simpler compared to CL. The method trains the main task with the alignment loss/task rather than training sequentially like CL. CL may not take advantage of domain-specific alignment, lowering zero-shot performance.

Compared to CL which requires GBs of parallel data, the present method is more efficient. Only one transformer model is used, whilst CL uses two models, making the training more compute-heavy. In terms of performance and generalization, the present method has better in-domain (I.I.D) performance than both translate+train and CL.

The method described herein can therefore improve state-of-the-art models in cross-lingual natural language understanding and classification tasks such as adversarial paraphrasing.

The concept may be extended to having multiple tasks in multiple languages.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. An apparatus for cross-lingual training between a source language and at least one target language, the apparatus comprising one or more processors configured to perform the steps of:
receiving a plurality of input data elements, each of the plurality of input data elements comprising a first linguistic expression in the source language and a second linguistic expression in the target language, the first and the second linguistic expressions having corresponding meaning in their respective languages; and
training a neural network model by repeatedly:
i. selecting one of the plurality of input data elements;
ii. obtaining a first representation of the first linguistic expression of the selected input data element by means of the neural network model;
iii. obtaining a second representation of the second linguistic expression of the selected input data element by means of the neural network model;
iv. forming a first loss in dependence on the performance of the neural network model on the first linguistic expression;
v. forming a second loss indicative of a similarity between the first representation and the second representation; and
vi. adapting the neural network model in dependence on the first and second losses.

2. An apparatus as claimed in claim 1, wherein the performance of the neural network model is determined based on the difference between an expected output and an actual output of the neural network model.

3. An apparatus as claimed in claim 1, wherein the neural network model forms representations of the first and second linguistic expressions according to their meaning.

4. An apparatus as claimed in claim 1, wherein at least some of the first and second linguistic expressions are sentences.

5. An apparatus as claimed in claim 1, wherein prior to the training step the neural network model is more capable of classifying linguistic expressions in the first language than in the second language.

6. An apparatus as claimed in claim 1, wherein the neural network model comprises a plurality of nodes linked by weights and the step of adapting the neural network model comprises backpropagating the first and second losses to nodes of the neural network model so as to adjust the weights.

7. An apparatus as claimed in claim 1, wherein the second loss is formed in dependence on a similarity function representing the similarity between the representations by the neural network model of the first and second linguistic expressions of the selected input data element.

8. An apparatus as claimed in claim 1, wherein the neural network model is capable of forming an output in dependence on a linguistic expression and the training step comprises forming a third loss in dependence on a further output of the neural network model in response to at least the first linguistic expression of the selected data element and adapting the neural network model in response to that third loss.

9. An apparatus as claimed in claim 8, wherein the output represents a sequence tag for the first linguistic expression.

10. An apparatus as claimed in claim 8, wherein the output represents predicting a single class label or a sequence of class labels for the first linguistic expression.

11. A data carrier storing in non-transient form data defining a neural network classifier model being capable of classifying linguistic expressions of a plurality of languages, and the neural network classifier model being configured to output the same classification in response to linguistic expressions of the first and second languages that have the same meaning as each other, wherein the neural network classifier model is trained by a apparatus, the apparatus comprising one or more processors configured to perform the steps of:
receiving a plurality of input data elements, each of the plurality of input data elements comprising a first linguistic expression in the source language and a second linguistic expression in the target language, the first and the second linguistic expressions having corresponding meaning in their respective languages; and
training a neural network model by repeatedly:
i. selecting one of the plurality of input data elements;
ii. obtaining a first representation of the first linguistic expression of the selected input data element by means of the neural network model;
iii. obtaining a second representation of the second linguistic expression of the selected input data element by means of the neural network model;
iv. forming a first loss in dependence on the performance of the neural network model on the first linguistic expression;
v. forming a second loss indicative of a similarity between the first representation and the second representation; and
vi. adapting the neural network model in dependence on the first and second losses.

12. An apparatus as claimed in claim 11, wherein the performance of the neural network model is determined based on the difference between an expected output and an actual output of the neural network model.

13. An apparatus as claimed in claim 11, wherein the neural network model forms representations of the first and second linguistic expressions according to their meaning.

14. An apparatus as claimed in claim 11, wherein at least some of the first and second linguistic expressions are sentences.

15. An apparatus as claimed in claim 11, wherein prior to the training step the neural network model is more capable of classifying linguistic expressions in the first language than in the second language.

16. An apparatus as claimed in claim 11, wherein the neural network model comprises a plurality of nodes linked by weights and the step of adapting the neural network model comprises backpropagating the first and second losses to nodes of the neural network model so as to adjust the weights.

17. An apparatus as claimed in claim 11, wherein the second loss is formed in dependence on a similarity function representing the similarity between the representations by the neural network model of the first and second linguistic expressions of the selected input data element.

18. An apparatus as claimed in claim 11, wherein the neural network model is capable of forming an output in dependence on a linguistic expression and the training step comprises forming a third loss in dependence on a further output of the neural network model in response to at least the first linguistic expression of the selected data element and adapting the neural network model in response to that third loss.

19. An apparatus as claimed in claim 18, wherein the output represents a sequence tag for the first linguistic expression.

20. A method for cross-lingual training between a source language and at least one target language, the method comprising performing the steps of:
receiving a plurality of input data elements, each of the plurality of input data elements comprising a first linguistic expression in the source language and a second linguistic expression in the target language, the first and the second linguistic expressions having corresponding meaning in their respective languages; and
training a neural network model by repeatedly:
i. selecting one of the plurality of input data elements;
ii. obtaining a first representation of the first linguistic expression of the selected input data element by means of the neural network model;
iii. obtaining a second representation of the second linguistic expression of the selected input data element by means of the neural network model;
iv. forming a first loss in dependence on the performance of the neural network model on the first linguistic expression;
v. forming a second loss indicative of a similarity between the first representation and the second representation; and
vi. adapting the neural network model in dependence on the first and second losses.
